(19) United States
(12) Patent Application Publication
(10) Pub. No.: US 2003/0233369 A1
(43) Pub. Date: Dec. 18, 2003

(54) Data classifying device, and active learning method used by data classifying device and active learning program of data classifying device

(75) Inventor: Manabu Sassano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/460,209

(22) Filed: Jun. 13, 2003

(30) Foreign Application Priority Data
Jun. 17, 2002 (JP) 2002-175509

(51) Int. Cl. G06F 17/00

(52) U.S. Cl. 707/102

(57) ABSTRACT

Herein disclosed is a data classifying device whereby support vector machine performs a data classification based on a learning result obtained by performing an active learning method, comprises: a correct answer database adapted to store therein examples and their correct answer classes; a pooling section adapted to pool examples to which correct answer classes are not yet assigned; an SVM learning section adapted to perform learning of the support vector machine by using correct answer examples stored in the correct answer database; an SVM classifying section adapted to store therein the learning result obtained by the SVM learning section and perform the data classification based on the learning result thus stored therein; an active learning-purposed example selecting section adapted to select examples for use in the active learning from the pooling section by using the learning result; and a pooled example increasing section adapted to acquire new examples to which correct answer classes are not yet assigned and pool them in the pooling section such that the number of examples stored in the pooling section is increased.

With the data classifying device thus configured, it is possible to reduce time required to improve accuracy in data classifying and to speed up the improvement of the accuracy, thereby providing higher accuracy.

### BACKGROUND OF THE INVENTION

1. Field of the Invention

The present invention relates to a data classifying device wherein a support vector machine conducts a data classification based on a learning result obtained by performing an active learning method, such an active learning method used by the data classification device and an active learning program of the data classification device.

2. Description of the Related Art

A support vector machine (hereinafter, referred to as an “SVM”) is a kind of classifying mechanism that decides which of two classes any unknown example belongs to by using or referring to training examples each belonging to either one of the two classes (“The Nature of Statistical Learning Theory”, V. Vapnik, Springer-Verlag), and applied to various fields such as a pattern recognition inclusive of speech recognition, character recognition and image recognition, and a medical diagnosis field.

Various kinds of classifying devices or methods created based on such SVMs have been developed, and one of them is recently being developed with use of an active learning method. In connection with the active learning method, an ordinary learning method is implemented in such a manner that a trained side learns by using given examples just as they are and without selecting particular examples to be used for learning. On the contrary, the active learning method includes a step of requesting which of examples requires a correct answer by the trained side. In detail, the trained side is taught on the correct answer to a certain example, among a lot of unknown examples (as unlabeled examples or examples to which correct answers are not yet assigned), so that higher accuracy in classification of examples is obtainable.

On the assumption that there is provided a certain group of documents (document pool) in which individual document belongs to either one of classes A and B, the following description is provided to explain a specific instance of the active learning method when a classifier adapted to classify these documents (document classification) is trained. First of all, a person (human) gives respective correct answer classes to a small number of documents (from some documents to dozens of documents) as labeled examples or examples to which correct answer classes are assigned (examples assigned correct answer classes). Hence, a classifier is created by learning from such labeled documents according to a certain method.

Next, the trained side is forced to select a predetermined number of documents which are desired to know their correct answer classes by using the classifier created as above. Then, the person gives respective correct answer classes to the predetermined number of documents. Hence, another classifier is created by learning from such labeled documents. It should be noted that such process steps are repeated over plural cycles.

In the active learning, the correct answer class tends to be given to a confusing or vague document in preference to documents which are easily inferable by the classifier. This is because it is possible to enhance learning efficiency by giving labeled examples to the classifier in such a way rather than by giving labeled examples thereto at random. Furthermore, it can be expected that accuracy obtainable by giving the labeled examples to the classifier at random can equivalently be achieved by giving less number of the labeled examples thereto. Accordingly, if a classifying device that classifies documents is produced by using the active learning, it is possible to reduce cost for creation of the labeled examples.

The following description is provided to explain conventional data classifying device using such an active learning method based on SVM and learning method used by the former with reference to FIGS. 4 and 5. FIG. 4 is a schematic diagram showing the conventional data classifying device, and FIG. 5 is a flow chart showing process steps according to the active learning method used by the conventional data classifying device.

As shown in FIG. 4, the conventional data classifying device comprises: a labeled example (or correct answer example) database (DB) 101 adapted to store therein examples and their correct answer classes (as examples to which correct answer classes are assigned); a pooling section 103 adapted to pool therein examples to which correct answer classes are not yet assigned (unlabeled examples or examples whose correct answer classes are unknown); an SVM learning section 104 adapted to perform learning by using the labeled examples stored in the labeled example database 101 by support vector machine; an SVM classifying section 105 adapted to store a learning result obtained in the SVM learning section 104; an active learning-purposed example selecting section 106 adapted to select examples for use in the active learning from the pooling section 104 by using the SVM classifying section 105; and a correct answer inquiring section 107 adapted to inquire correct answers for unlabeled examples (or examples to which correct answer classes are not yet assigned) received from the active learning-purposed example selecting section 106. In the answer inquiring section 107, the correct answer classes acquired by personnel operations are assigned to the examples to which the correct answer classes are not yet assigned. Upon assignment of the correct answer classes performed in the correct answer inquiring section 107, the correct answer inquiring section 107 is configured to send to the active learning-purposed example selecting section 106 both of the correct answer classes and the examples to which the correct answer classes have been assigned.

The conventional data classifying device as described above will operate as shown in FIG. 5, when its active learning is performed.

First of all, a small number of labeled examples is prepared and then stored in the labeled example database 101 (S00). Next, the SVM learning section 104 performs learning by using the labeled examples stored in the labeled example database 101 (S01). The learning result obtained in the SVM learning section 104 at the step of S01 is stored in the SVM classifying section 105 (S02).

Next, the active learning-purposed example selecting section 106 examines or checks respective examples from the pooling section 103 and selects some of them to be used for the active learning (S03). The examples selected in the active learning-purposed example selecting section 106 at the step of S03 are sent to the correct answer inquiring section 107. The correct answer inquiring section 107 performs inquies to the person or any other correct answer decidable machine and assigns corresponding correct answer classes to the examples selected as above (S04). The example thus assigned the correct answer classes are sent to the active learning-purposed example selecting section 106. The active learning-purposed example selecting section 106 stores the examples and corresponding correct answer classes in the labeled example database 101, thereafter the process flow returns to the step S01. It will be appreciated by those of ordinary skill in the art that this ending condition may duly be varied in dependence on circumstances.

As the conventional data classifying device and active learning method thereof as above, a typical device and method thereof are known wherein an example by which an output of the SVM is nearest to zero is selected from the pooling section and then a correct answer class is assigned to that example (Please see, e.g., Simon Tong and Daphne Koller, “Support Vector Machine Active Learning with Application to Text Classification”, in Proc. of the 17th International Conference on Machine Learning, 2000 and the like).

With regard to the creation of such a data classifying device as above, the greater an example set (pool: an aggregation of examples to be chased up for assigning correct answer classes thereto) stored in the pooling section 103 and used to obtain a definitive learning result, the higher accuracy of the data classifying device. That is, a greater example set can achieve the data classifying device in its accuracy higher than that achieved by a smaller example set. Thus, in order to enhance the accuracy, the pooling section having a large pool has conventionally be provided.

However, in the conventional data classifying device as described above, if an example set (pool) to be stored in the pooling section 103 is initially enlarged, it consumes a lot of time to improve the accuracy as compared to the case of a smaller pool, thereby disadvantageously raising a problem of delay in improvement of the accuracy.

Accordingly, an object of the present invention is to provide a data classifying device, a data classifying method and a data classifying program, whereby time required to improve accuracy in data classification can be reduced and the improvement of the accuracy is speeded up, thereby providing higher accuracy.

### SUMMARY OF THE INVENTION

In order to address the above-mentioned problem and the other, there is provided a data classifying device whereby support vector machine performs a data classification based on a learning result obtained by performing an active learning method, comprising: a labeled example (correct answer example) database adapted to store therein examples and correct answer classes to be assigned to those examples as examples to which correct answer classes are assigned; a pooling section adapted to pool examples to which correct answer classes are not yet assigned; an SVM learning section adapted to perform learning of the support vector machine by using correct answer examples stored in the correct answer database; an SVM classifying section adapted to store therein the learning result obtained by the SVM learning section and perform the data classification based on the learning result thus stored therein; an active learning-purposed example selecting section adapted to select examples for use in the active learning from the pooling section based on the learning result; and a pooled example increasing section adapted to acquire new examples to which correct answer classes are not yet assigned and pool them in the pooling section such that the number of examples stored in the pooling section is increased.

In this data classifying device, the pooled example increasing section is characterized by increasing the number of examples based on the number of support vectors in the SVM classifying section. According to another aspect of the present invention, the pooled example increasing section is characterized by increasing the number of examples based on the number of support vectors and the number of pooled examples (i.e., the total number of examples to which correct answer classes are assigned and stored in the correct answer example database and the number of examples to which correct answer classes are not yet assigned and pooled in the pooling section). According to yet anther aspect of the present invention, the pooled example increasing section is characterized by increasing the number of examples based on the comparison result of a predetermined value and a ratio of the number of support vectors with the number of pooled examples (i.e., the total number of examples to which correct answer classes are assigned and stored in the correct answer example database and examples to which correct answer classes are not yet assigned pooled in the pooling section). According to a further aspect of the present invention, the pooled example increasing section is characterized by increasing the number of examples based on an increasing rate of the number of support vectors.

Also, in this data classifying device, the pooled example increasing section is characterized by increasing in a stepwise the number of examples pooled in the pooling section. Furthermore, the pooled example increasing section is characterized by increasing the number of examples pooled in the pooling section until the total number of examples to which correct answer classes are assigned and examples to which correct answer classes are not yet assigned is increased by n times (“n” is a number more than 1).

According to the present invention, there is also provided an active learning method used by a data classifying device, whereby support vector machine performs a data classification based on a learning result obtained by performing an active learning method, comprising the steps of: storing examples to which correct answer classes are assigned as labeled examples; performing a learning of the support vector machine based on the labeled examples; keeping a learning result obtained by performing the learning; selecting examples to which correct answer classes are not yet assigned from a pooling section by using the learning result; and increasing the number of examples pooled in the pooling section based on the kept learning result.

According to the present invention, there is also provided an active learning program for use in data classification, which is stored in a storage medium and adapted to make a computer to perform an active learning of a data classifying device whereby support vector machine performs a data classification based on a learning result obtained by performing an active learning method, comprising the steps of: storing examples to which correct answer classes are assigned as labeled examples; performing learning of the support vector machine based on the labeled examples; keeping a learning result obtained by performing the learning; selecting examples to which correct answer classes are not yet assigned from a pooling section by using the learning result; and increasing the number of examples pooled in the pooling section based on the kept learning result.

Thus, according to the present invention, it is possible to provide a data classifying device, an active learning method used by the data classifying and an active learning program of the data classifying device, whereby time required to improve accuracy in data classifying can be reduced and the improvement of the accuracy can be speeded up, thereby providing higher accuracy.

The SVM used in the present invention is a kind of non-parametric pattern classifier which is characterized in that (1) the SVM is one aiming at improvement of generalization performance by maximizing the margin of a separating hyperplane (“the margin of a separating hyperplane” can be defined as being d++d. if d+(d−) is the shortest distance from the separating hyperplane to the closest positive (negative) example; and that (2) the SVM is, regardless of being a non-linear separator, formulated as a liner separator due to its kernel characteristic (by using this formulation, a pattern separating hyperplane is obtainable as a resolution of a two-dimensional optimum program). Also, the separating hyperplane is expressed by a linear combination of input patterns but characterized by data near a boundary between classes. Thus, such data by which the separating hyperplane is characterized is referred to as “support vector”.

On the other hand, the active learning is one method which comprises a step of selecting an example which is one of a large number of examples whose correct answers are unknown so as to obtain higher accuracy if a correct answer is taught for the example as comparison with the case of other example selection. The classifying device based on SVM according to the present invention is particularly characterized by gradually increasing the number of pooled examples, and composed of a section for giving examples to which correct answers are assigned, a section for performing an active learning based on the examples and a section for gradually increasing the number of pooled examples whose correct answers are unknown.

These and other aspects of the present invention will be apparent from the following specific description, given by way of example, with reference to the accompanying drawings.

### BRIEF DESCRIPTION OF THE DRAWINGS

FIG. 1 is a schematic block diagram showing a data classifying device using an active learning method based on SVM according to a preferred embodiment of the present invention;

FIG. 2 is a flow chart showing process steps of the data classifying device;

FIG. 3 is a flow chart showing detailed steps of processing A in FIG. 2;

FIG. 4 is a schematic block diagram showing a conventional classifying device using an active learning based on SVM; and

FIG. 5 is a flow chart showing process steps according to an active learning method used by the conventional data classifying device.

### DESCRIPTION OF PREFERRED EMBODIMENTS

Hereinafter, preferred embodiments of the present invention will be described in detail with reference to the accompanying drawings.

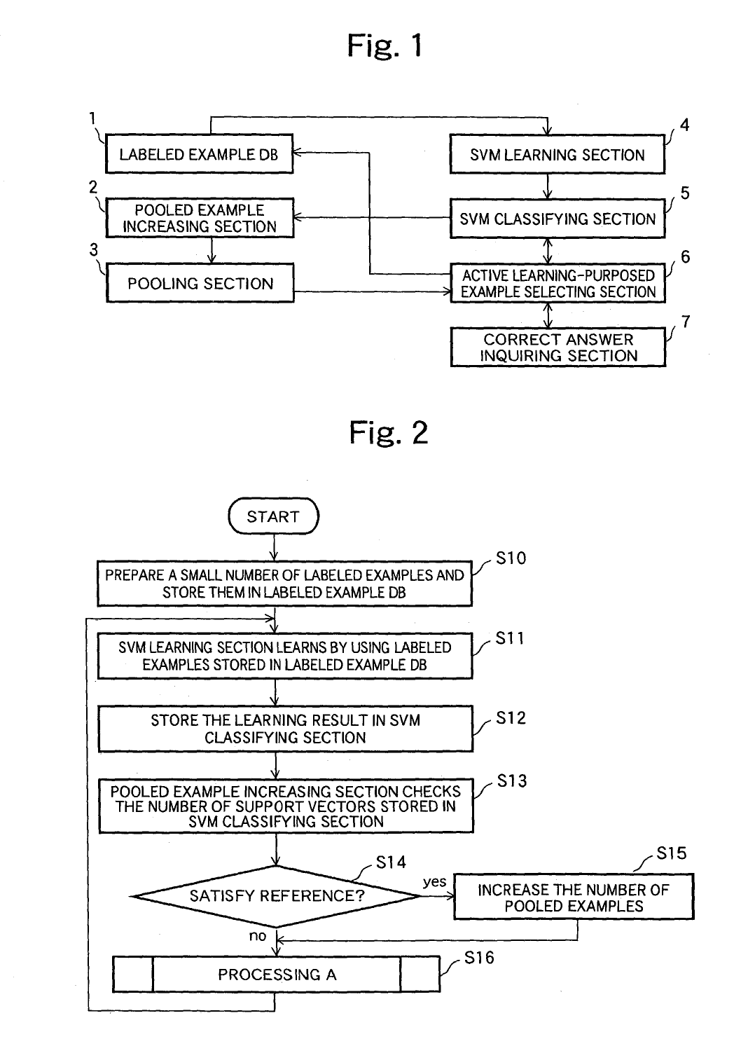

First of all, the following description is provided to explain a data classifying device according to the present invention, as a preferred embodiment, of with reference to FIG. 1. In FIG. 1 is a schematic block diagram showing the data classifying device using an active learning method based on SVM. This data classifying device comprises: a correct answer example (labeled example) database 1; a pooled example increasing section 2; a pooling section 3; an SVM learning section 4; an SVM classifying section 5; an active learning-purposed example selecting section 6; and a correct answer inquiring section 7.

The correct example database (DB) 1 is a database adapted to store therein examples and their correct answer classes as correct answer examples. The pooled example increasing section 2 is adapted to acquire examples whose correct classes are unknown (or examples to which their correct answer classes are not yet assigned) from any (not shown) input device and then to send the examples acquired to the pooling section 3 on a posterior stage, and further adapted to increase the number of examples stored in the pooling section 3. As described later on, the data classifying device using the active learning based on SVM according to the present invention is significantly different from the conventional data classifying device as shown in FIG. 4 in that the data classifying device according to the present invention possesses the pooled example increasing section 2. This pooled example increasing section 2 is capable of increasing the number of examples (to be pooled) stored in the pooling section 3 based on information (e.g., based on the number of support vectors stored in the SVM classifying section 5) stored in the SVM classifying section 5 as described later on. The pooling section 3 is an information storage section adapted to store therein examples to which correct answer classes are not yet assigned.

The SVM learning section 4 is a part at which the SVM performs learning. In detail, the support vector machine in the SVM learning section 4 learns by using correct answer examples stored in the correct answer example database 1. A learning result obtained by the SVM learning section 4 is sent to the SVM classifying device 5 on a posterior stage as predetermined parameters and their values.

The SVM classifying device 5 is adapted to classify classes of examples based on predetermined estimation values. In general, in the case of the SVM, if an unknown example is given, the SVM outputs such a predetermined estimation value. The SVM determines a class for the example based on such an estimation value. Similarly, the SVM classifying section 5 according to the present invention also classifies examples, respectively, based on predetermined estimation values. The SVM classifying section 5 receives parameters and their values obtained as the result of learning performed in the SVM learning section 4, and stores support vectors based on the parameters and values. The SVM classifying section 5 classifies examples into predetermined classes, respectively, based on parameters and its values stored therein for certain examples. Accordingly, the number of support lo vectors stored in the SVM classifying section 5 will increase as the learning is repetitively performed in the SVM learning section 4.

The active learning-purposed example selecting section 6 selects predetermined examples from a set of unlabeled examples (or examples to which correct- answer classes are not yet assigned) pooled in the pooling section 3. In particular, such a selection is performed by using the SVM classifying section 5 (the learning result). Such a method of example selection using the SVM classifying section 5 may be, but is not exclusively limited to, a selection method that is performed based on an absolute value of an estimation value which is outputted from the SVM classifying section 5 based on the learning result. For instance, the selection method may be performed by selecting a predetermined number of examples each of which is nearest to zero as an absolute value of estimation value, i.e., examples each located near to the boundary of two classes, or by selecting examples each within a predetermined range. This predetermined number or range can duly be empirically defined.

Thereafter, the active learning-purposed example selecting section 6 sends the examples thus selected to the correct answer inquiring section 7. The correct answer inquiring section 7 outputs (displays) the examples thus received so as to assign correct answer classes to the examples via a person or by using an appropriate method. Then, the correct answer inquiring section 7 returns the correct answer classes thus assigned and the corresponding examples as labeled examples (or correct answer examples) to the active learning-purposed example selecting selection 6.

Upon return of the labeled examples to the active learning purposed-example selecting section 6, the active learning purposed-example selecting section 6 sends the labeled examples to the labeled example database 1 to be stored therein.

In the data classifying device using the active learning method based on SVM, the pooled example increasing section 2 gradually increases examples pooled in the pooling section 3 by referring to the estimation values and the number of support vectors stored in the SVM classifying section 5.

In order to increase the number of examples pooled in the pooling section 3, the present invention may select one among many kinds of example increasing methods.

As an example increasing method, the pooled example increasing section 2 checks on the number of support vectors stored in the SVM classifying section 5 and, based on an increase of the number of support vectors, increases the number of examples stored in the pooling section 5. In this case, every the number of support vectors stored in the SVM classifying section 5 exceeds a predetermined number, the pooled example increasing section 2 may be configured to increase the number of examples pooled in the pooling section 3.

As another example increasing method, the pooled example increasing section 2, first of all, calculates a ratio of the number of support vectors stored in the SVM classifying section 5 and examples stored in both of the correct answer database 1 and the pooling section 3. If the ratio exceeds a predetermined value, more specifically, a ratio of the former to the latter exceeds 10%, the pooled example increasing section 2 may be configured to increase the number of examples pooled in the pooling section 3.

As yet another example increasing method, the pooled example increasing section 2 monitors an increasing rate regarding the number of support vectors stored in the SVM classifying section 5 and, based on this increasing rate, increases the number of examples pooled in the pooling section 3.

As described in Greg Schon & David Cohn, “Less is More: Active learning with Support Vector Machines”, in Proc. of the 17th International Conference on Machine learning, 2000, there is a phenomenon found in the active learning with SVM where the accuracy has passed its peak or any more improvement in the accuracy can not be prospective when the increasing rate regarding the number of support vectors begins to reduce. Hence, the increasing rate regarding the number of support vectors is checked according to the present invention. Then, when the increasing rate regarding the number of support vectors has been reduced, the pooled example increasing section 2 may be configured to increase the number of examples pooled in the pooling section 3.

In accordance with the present invention, the SVM may be created by a method by J. C. Plaft for instance (see “Fast training of support vector machine using sequential minimal optimization” in B. Schoelkopt, C. J. C. Burges, and A. J. Smola, editors, Advances in Kernel Methods-Support Vector Learning, Pages 185-208, MIT Press, 1999).

Regarding how many examples are increased in the pooling section 3, an appropriate number of examples may duly be selected in dependence on circumstances at the time when the number of examples in the pooling section 3 is increased. In accordance with the present invention, new examples are added to the pooling section 3 until the total number of labeled examples and unlabeled examples is increased by n times (“n” is a number more than 1). For instance, in the event that the number of examples in the pooling section 3 is increased until the total number of labeled examples and unlabeled examples is doubled (is increased by 2 times) for instance, new 1000 unlabeled examples will be added to the pooling section 3 if correct answer classes have been assigned to t examples at a certain time while 1000-t examples whose correct answers are unknown (unlabeled examples) are given. As a result, the number of examples in the pooling section 3 is 2000 which is double of the total number of examples before addition (1000). In the event that the number of examples in the pooling section 3 is increased by 2 times at the next time, new 2000 examples will be added thereto (i.e., the number of examples in the pooling section 3 is 4000).

Thus, the data classifying device using the active learning method based on SVM according to the present invention may be used preferably as a classifying device having a learning function capable of extracting an information of proper noun and the like from electronic document and data with high accuracy even if the number of examples is small. For instance, with the data classifying device using the active learning method based on SVM according to the present invention, it is possible to perform data classification in many fields such as text classification, pattern analysis, medical diagnostic system and marketing analysis with high accuracy.

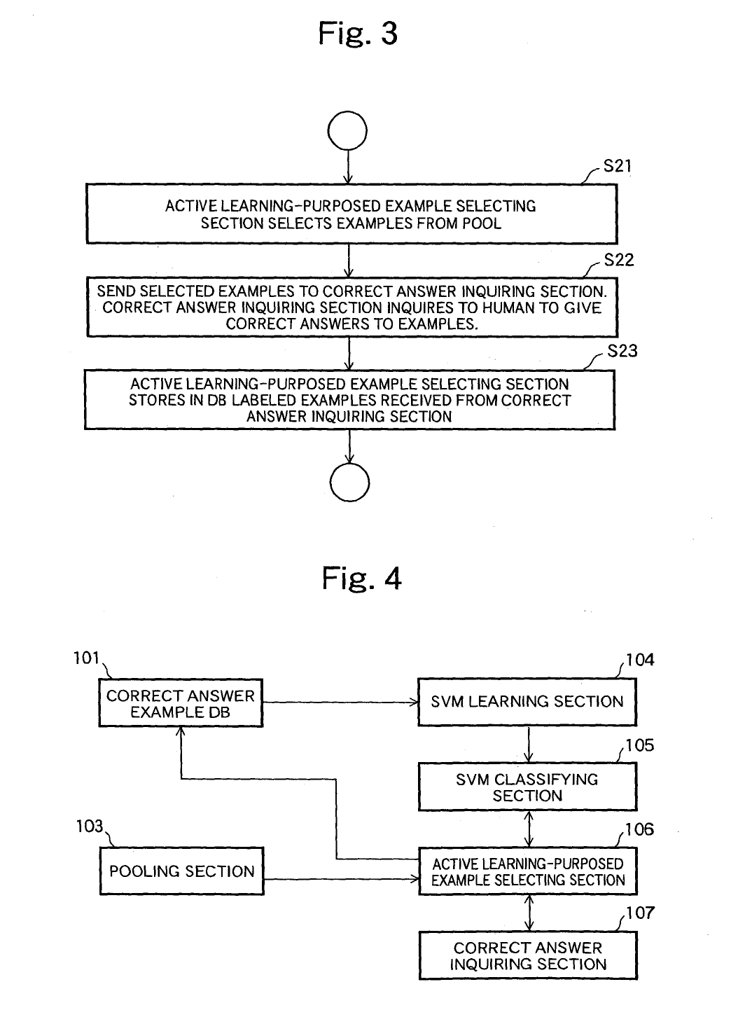

The following description is provided to explain an operation during active learning of the data classifying device according to the present invention as well as the active learning method used by the data classifying device and the active learning program with reference to FIGS. 2 and 3. FIGS. 2 and 3 are flow charts showing process steps during the active learning of the data classifying device using the active learning based on SVM.

In FIG. 2, first of all a small number of examples are prepared and stored in the correct answer example database 1 (S10). Then, learning is performed in the SVM learning section 4 by using correct answer examples stored in the correct answer examples database 1 (S11). The learning result obtained from the learning performed in the SVM learning section 4 in the step of S11 is stored in the SVM classifying section 5 (S12).

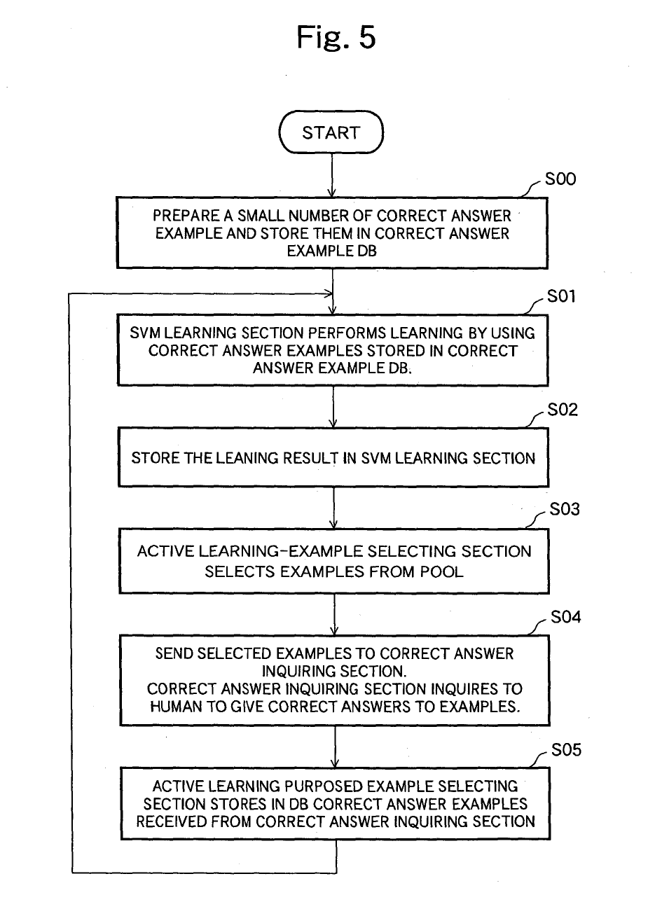

These process steps just mentioned above are similar to the process steps performed according to the active learning method used by the conventional data classifying device (S00-S02 in FIG. 5).

Next, the pooled example increasing section 2 according to the present invention checks on the number of support vectors stored in the SVM classifying section 5 (S13). Then, it is decided whether or not the number of support vectors satisfies a predetermined reference (S14). In the step of S14, if the number of support vectors satisfies the predetermined reference (S14: Yes), the process proceeds to the step of S15, where the number of examples in the pooling section 3 is made to be increased (S15), and then flows to the step of S16 (processing A).

However, in the step of S14, if the number of support vectors does not satisfy the predetermined reference (S14: No), the process proceeds directly to the step of S16 (processing A), not through the step of S15.

The processing A corresponds to the steps of S03-S05 followed according to the active learning method used by the conventional data classifying device as shown in FIG. 5, and includes the steps of S21-S23 as shown in FIG. 3.

In detail, the active learning purposed-example selecting section 6 checks respective examples in the pooling section 3 and selects examples to be use for the active learning (S21). Subsequently, the examples selected by the active learning purposed-example selecting section 6 are sent to the correct answer inquiring section 7, where the correct answer inquiring section 7 performs inquiries to a person or any other correct answer decidable machine and assigns corresponding correct answer classes to the examples selected as above (S22). The active learning purposed-example selecting section 6, which has received the examples to which the correct answer classes have been assigned (labeled examples) return from the correct answer inquiring section 7, stores the labeled examples in the correct answer example database 1 (S23), thereafter the process flow returns to the step of S11.

It will be appreciated by those of ordinary skill in the art that this ending condition may duly be varied in dependence on circumstances. For instance, after a loop from the step of S11 to the step of S23 has been repetitively performed over a predetermined period of time, the flow may be ended.

Also, on the assumption that a predetermined cost is required to know a correct answer class for an example, the loop from the step of S11 to the step of S23 has been repetitively performed until the predetermined cost has been consumed, and thereafter the process flow may be ended. For instance, on the assumption that it costs ¥1,000 to inquire for the correct answer class and ¥100,000 is reserved as the predetermined cost, it is possible to repeat the loop from the step of S11 to the step of S23 over the frequency of 100 times.

In order to define another ending condition, the present invention can employ a method of checking the accuracy by preparing test-purposed examples aside from learning-purposed examples as described above. In this case, every a learning is finished, its accuracy is checked by using the test-purposed examples. When such accuracy thus checked exceeds a target value, the process flow may be ended.

According to the present invention, a computer can be made to perform the active learning in the data classifying device based on SVM by storing in a computer-readable storage medium the flow or loop from the step of S11 to the step of S23 as the active learning program for the data classifying device. The computer readable storage medium as mentioned above comprises either one of a CD-ROM, a flexible disk (FD), a DVD disk, an opto-magnetic disk, a portable storage medium such as an IC card and the like, a database storing computer programs, the other computer or its data base, or a transmission medium on a transmission line.

While embodiments of the invention have been illustrated and described, it is not intended that these embodiments illustrate and describe all possible forms of the invention. The present invention can be applied to various systems without departing from the spirit and scope of the invention. For instance, the preferred embodiment according to the present invention is described as above by exemplifying a data classifying device, but the present invention is applicable to various kinds of uses in a text classifying device for classifying a text, a medical diagnostic system and the like.

As described above, the present invention is particularly effective at reducing time required to improve accuracy in data classifying and speeding up the improvement of the accuracy, thereby providing higher accuracy.

What is claimed is:

1. A data classifying device whereby support vector machine performs a data classification based on a learning result obtained by performing an active learning method, comprising:
a correct answer database adapted to store therein examples and correct answer classes to be assigned to the examples;
a pooling section adapted to pool examples to which correct answer classes are not yet assigned;
an SVM learning section adapted to perform learning of the support vector machine by using correct answer examples stored in said correct answer database;
an SVM classifying section adapted to store therein a learning result obtained by said SVM learning section and perform the data classification based on the learning result thus stored therein;
an active learning-purposed example selecting section adapted to select examples for use in the active learning from said pooling section by using the learning result; and
a pooled example increasing section adapted to acquire new examples to which correct answer classes are not yet assigned and pool them in the pooling section such that the number of examples stored in the pooling section is increased.

2. A data classifying device as claimed in claim 1, wherein said pooled example increasing section increases the number of examples based on the number of support vectors in said SVM classifying section.

3. A data classifying device as claimed in claim 1, wherein said pooled example increasing section increases the number of examples based on the number of support vectors and the total number of examples to which correct answer classes are assigned and which are stored in said correct answer example database and the number of examples to which correct answer classes are not yet assigned and which are pooled in said pooling section.

4. A data classifying device as claimed in claim 1, wherein said pooled example increasing section increases the number of examples based on a comparison result of a predetermined value and a ratio of the number of support vectors with the total number of examples to which correct answer classes are assigned and which are stored in said correct answer example database and examples to which correct answer classes are not yet assigned and which are pooled in said pooling section.

5. A data classifying device as claimed in claim 1, wherein said pooled example increasing section increases the number of examples based on an increasing rate of the number of support vectors.

6. A data classifying device as claimed in claim 1, wherein said pooled example increasing section increases in a stepwise the number of examples pooled in the pooling section.

7. A data classifying device as claimed in claim 1, wherein said pooled example increasing section increases the number of examples pooled in the pooling section until the total number of examples to which correct answer classes are assigned and examples to which correct answer classes are not yet assigned is increased by n times (“n” is a number more than 1).

8. An active learning method used by a data classifying device, whereby support vector machine performs a data classification based on a learning result obtained by performing an active learning method, comprising the steps of:
storing examples to which correct answer classes are assigned as labeled examples;
performing a learning of the support vector machine based on the labeled examples;
keeping a learning result obtained by performing the learning;
selecting examples to which correct answer classes are not yet assigned from a pooling section by using the learning result; and
increasing the number of examples pooled in the pooling section based on said kept learning result.

9. An active learning program for use in data classification, which is stored in a storage medium and adapted to make a computer to perform an active learning of a data classifying device whereby support vector machine performs a data classification based on a learning result obtained by performing an active learning method, comprising the steps of:
storing examples to which correct answer classes are assigned as labeled examples;
keeping a learning result obtained by performing a learning of the support vector machine based on the labeled examples;
selecting examples to which correct answer classes are not yet assigned from a pooling section by using the learning result; and
increasing the number of examples pooled in the pooling section based on said kept learning result.
